(19) United States
(12) Patent Application Publication
(10) Pub. No.: US 2007/0044378 A1
(43) Pub. Date: Mar. 1, 2007

(54) Plant watering, conservation and improvement control system

(76) Inventor: John P. Blouin, Jupiter, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 11/216,747

(22) Filed: Aug. 31, 2005

(51) Int. Cl. A01G 25/00

(52) U.S. Cl. 47/79

(57) ABSTRACT

A plant watering, conservation, and pollution control system includes a planter having a base, sidewalls, at least one drain hole, and vegetation root anchors depending from interior surfaces of the planter; an upwardly directed funnel having side overflow channel in fluid communication with one of the interior surfaces of the planter; and a float switch in electrical communication with a vegetation sprinkler system, the float switch disposed within the funnel at a horizontal level of the planter to which filling is desired.

### BACKGROUND OF THE INVENTION

The present invention responds to the need to provide outside concrete surfaces, roofs, balconies, and the like with vegetation, such as trees and large plants, that cannot be practically maintained, given the present state of the art of planters and means for watering thereof.

Applicable prior art are U.S. Pat. No. 2,134,647 (1936) to Savage, entitled Grass Plot Foundation; U.S. Pat. No. 4,534,142 (1985) to Drefahl, entitled Roof Covering; U.S. Pat. No. 5,595,021 (1997) to Ripley, entitled Rurfing System for Stadia; and U.S. Patent Publication No. US2003/0074836 A1 to Blouin, entitled Cypress Project.

### SUMMARY OF THE INVENTION

A plant watering, conservation, and air pollution control system, comprises a planter having a base, sidewalls, at least one drain hole, and vegetation root anchors depending from interior surfaces of said planter; and an upwardly directed funnel having side overflow means in fluid communication with one of said interior surfaces of said planter; and a float switch in electrical communication with a vegetation sprinkler system, said float switch disposed within said funnel at a horizontal level of said planter to which filling thereof is desired.

It is an object of the invention to provide a means of maintaining trees and large plants within planters resting upon concrete surfaces, roofs and balconies.

It is another object to provide a plant watering, conservation and air pollution control system.

The above and yet other objects and advantages of the present invention will become apparent from the hereinafter Brief Description of the Drawings, Detailed Description of the Invention and Claims appended herewith.

### DETAILED DESCRIPTION OF THE DRAWINGS

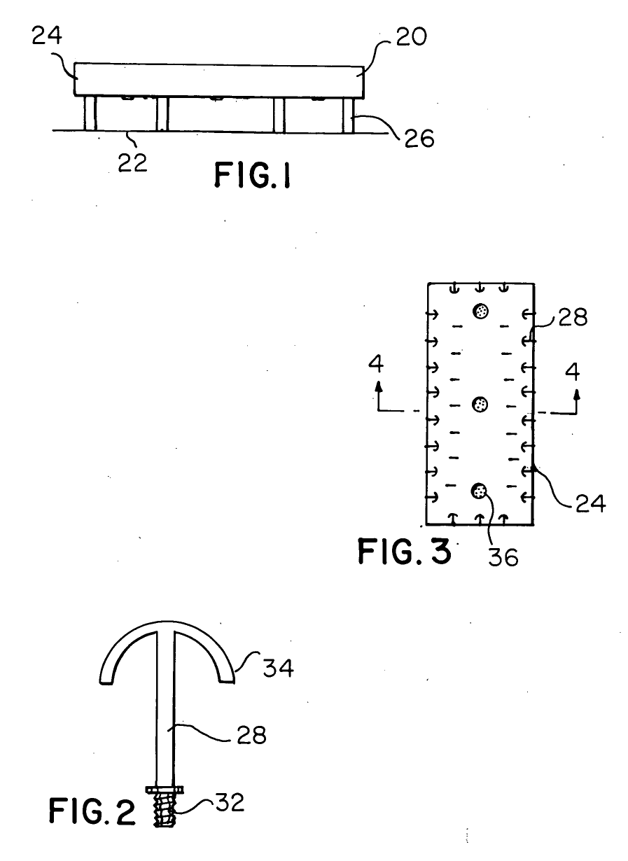

FIG. 1 is a front elevational view of the inventive structure.

FIG. 2 shows a plant anchor used within the planter.

FIG. 3 is a top plan view of FIG. 1.

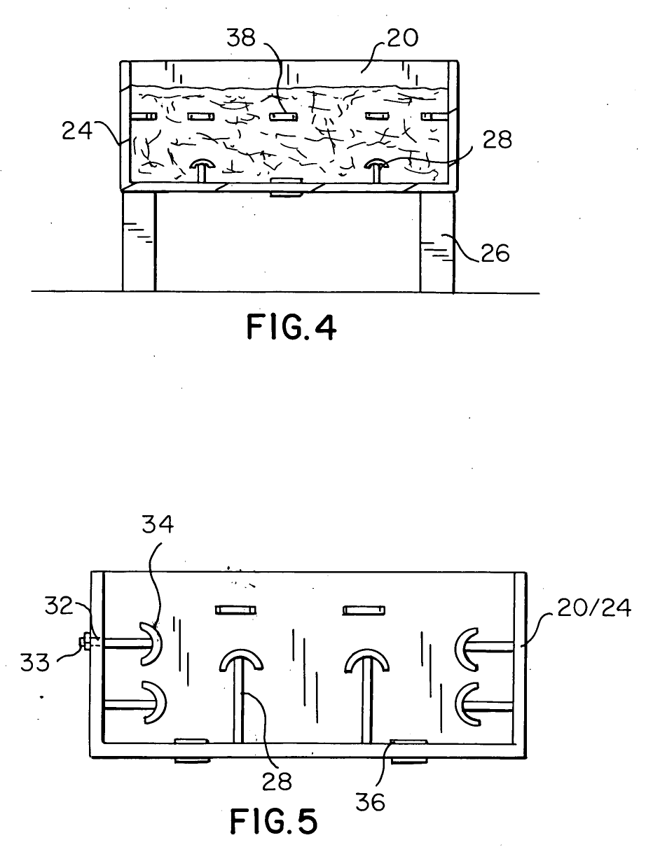

FIG. 4 is an enlarged vertical cross-sectional view of FIG. 1, showing earth therein.

FIG. 5 is a front breakaway view of FIG. 1 showing the plant foot anchors.

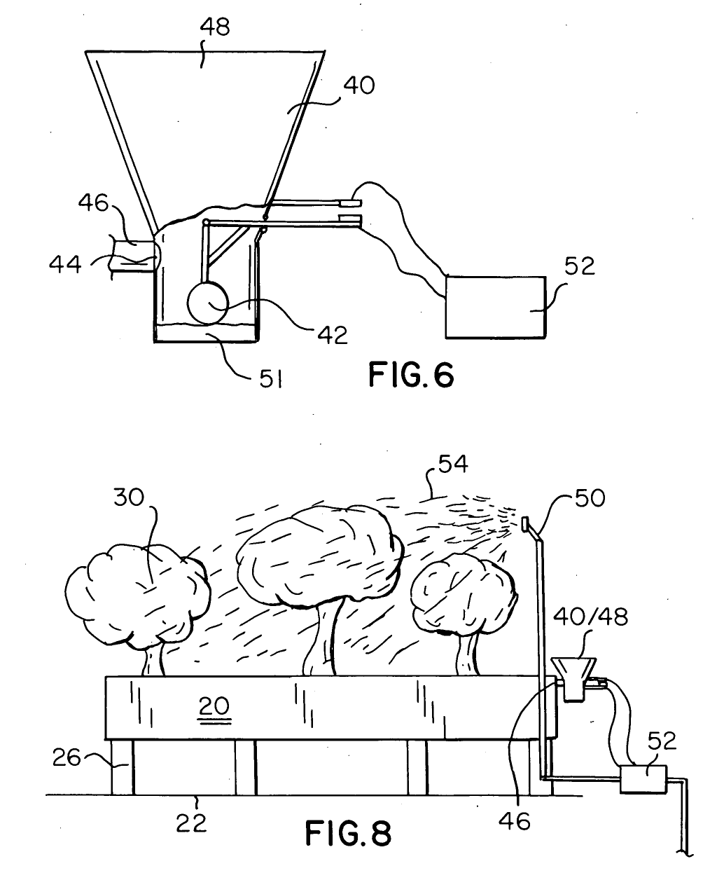

FIG. 6 is a view of the float switch mechanism.

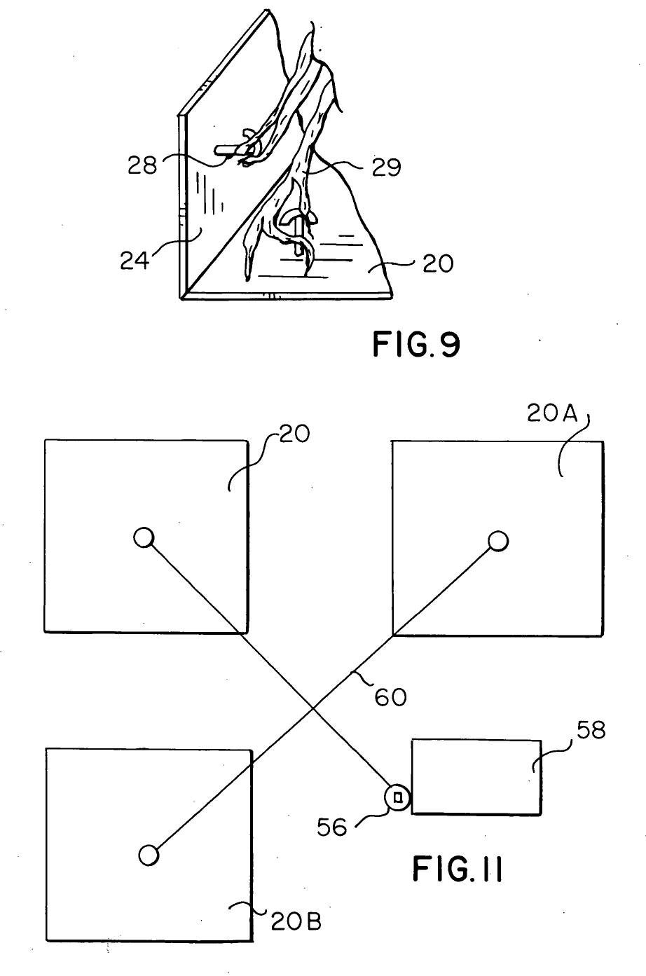

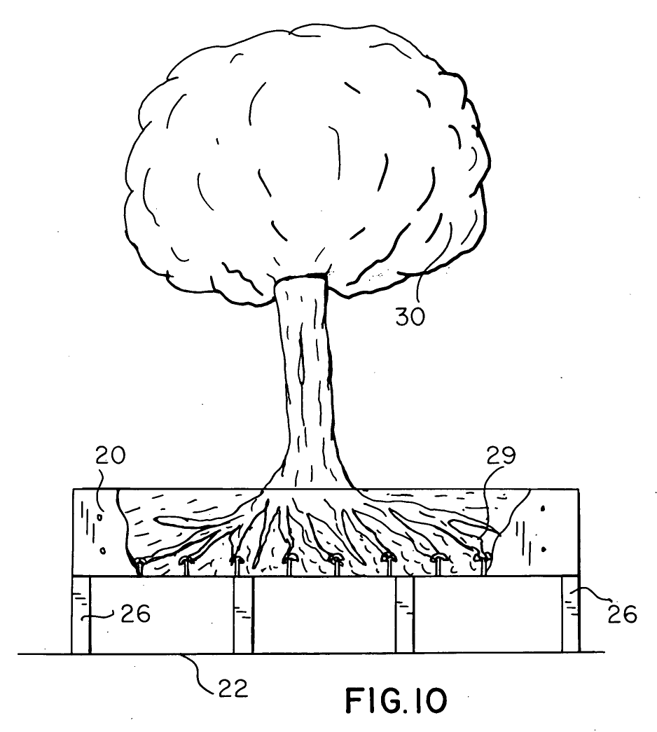

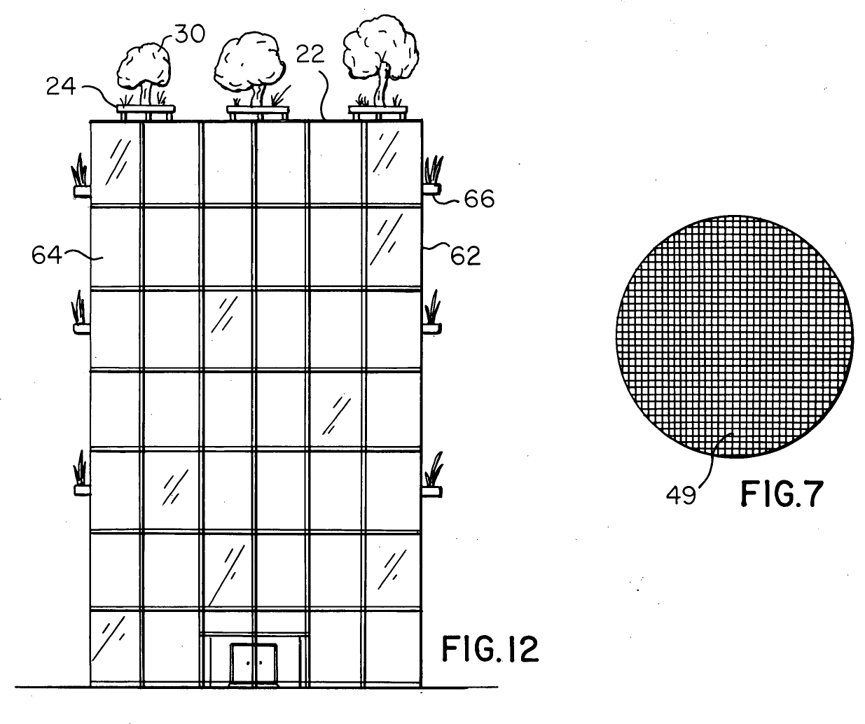

FIG. 7 is a top plan view of FIG. 6.

FIG. 8 is an operational view of the inventive system.

FIG. 9 is an enlarged interior view of the plantar and its root anchoring system.

FIG. 10 is an operational view of the system.

FIG. 11 is a system view showing the use of condensate from an air conditioning system.

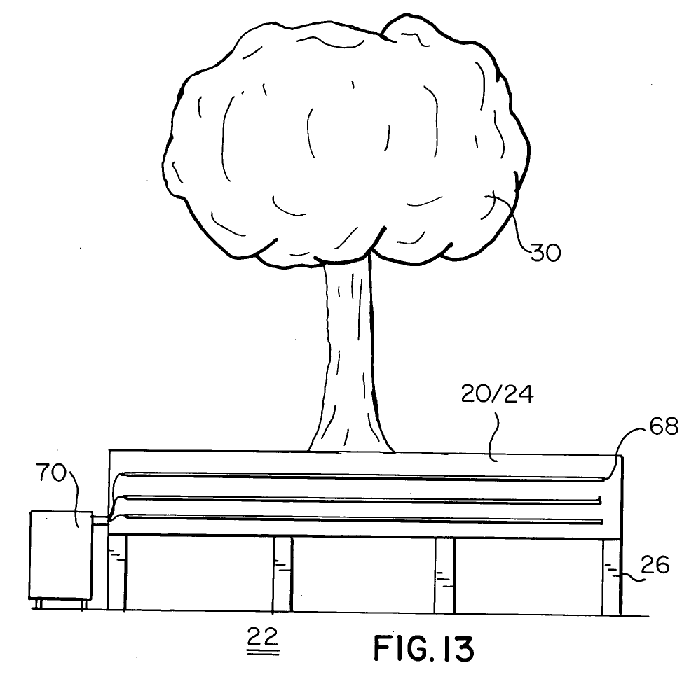

FIG. 12 shows use of the inventive system upon a high rise structure.

FIG. 1 3 is a view of a further embodiment of the system.

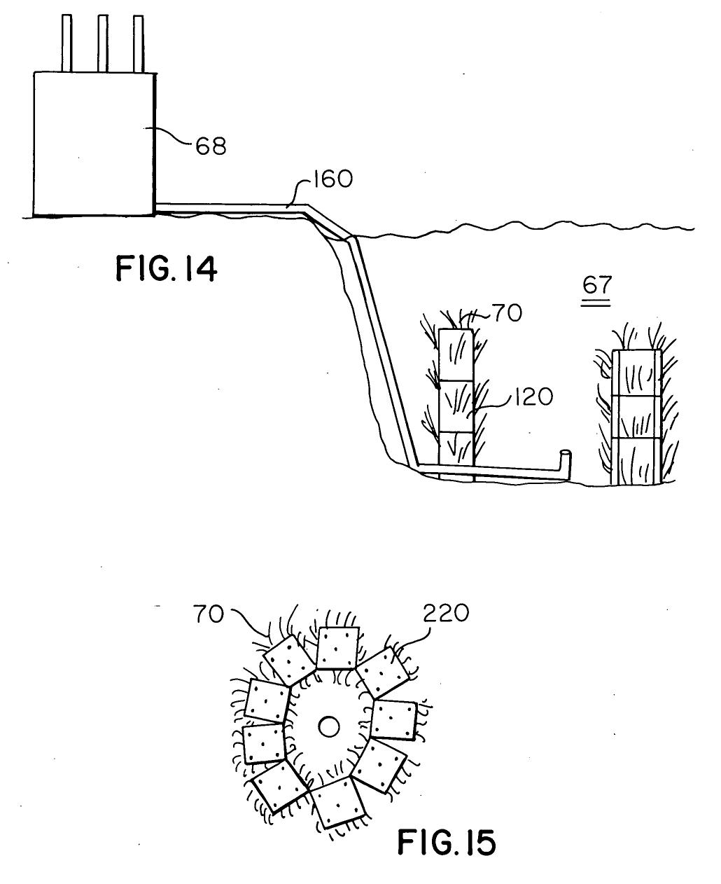

FIGS. 14-15 show a marine application of the present system.

### DETAILED DESCRIPTION OF THE INVENTION

With reference to FIGS. 1, 4, 5 and 8, there is shown a planter 20, preferably disposed on a roof or concrete surface 22. In a preferred embodiment, said planter 20 includes four contiguous sidewalls 24, support legs 26 and a multiplicity of root anchors 28, the purpose of which is to enhance engagement between the root systems 29 of vegetation 30 in earth 31 and sidewalls 24 of said planter 20 (see FIGS. 9-10). As may be noted with reference to FIGS. 2 and 5, a proximal end 32 of each anchor 28 may comprise a shredded portion which may be rigidly secured by nut means 33, to a sidewall 24 of the planter 20. A distal end 34 of each anchor 28 may comprise a semicircular element (see FIG. 2) to thereby facilitate engagement with roots 29 of vegetation 30 within planter 20.

Said planter 20 also includes one or more drainage holes 36 which, as may be noted in FIGS. 3 and 5, may assume various cross-sectional geometries. The planter 20 is also provided with sidewall overflow holes 38 (see FIG. 4) which, typically represent a predetermined level for water or moisture within the planter, so that in a event of excessive rain or watering in the planter, excess water may begin to escape through said overflow holes 38 before overflowing of the planter were to occur.

In the embodiment of FIGS. 6 and 8 is shown a funnel 40 which includes a float switch 42 and a side overflow hole 44 which is in fluid communication with a moisture level 46 inside of the planter at, or slightly beneath, the uppermost level of earth or of said overflow holes 38. As may be noted, a mouth 48 of the funnel 40 is positioned to accumulate rainfall and water from a sprinkler system 50 to substantially the same extent as the planter itself. Thereby, when water 51 within the funnel falls below the level of side overflow hole 44, sprinkler system pump 52 will actuate thereby turning on vegetation sprinklers 50 providing water 54 to plants, trees, or vegetation 30 within the planter 20. Shown in FIG. 7 is a screen 49 which is positioned in mouth 48 of funnel 40.

It should be appreciated that a moisture sensor (not shown) may be positioned within planter 20 to accomplish the same function as above described with reference to float switch 42.

In a further embodiment of the invention (see FIG. 11) a condensate pump 56 is attached to an air conditioning unit 58 that, through condensate lines 60, enable condensate to be provided to a plurality of planters 20, 20a and 20b. Therein, a fluid sensor means disposed either within said earth 31 of the planters or said float switch 42 serve as a means of actuation and interruption of the flow of compensate from pump 56 through lines 60, this as a function of said moisture level 46 (see FIG. 8) within planter 20. It is to be appreciated in a sprinkler system various 50 arrangements of condensate pump 56, air conditioner 58 and planters 20 may be provided.

The positioning of the present system on group surfaces 22 and sides 62 of a building 64 is shown in FIG. 12. Accordingly, balconies 66 of the building may be used in lieu of a roof to support the system. Therein, the planter may be employed without the use of legs 26, if desired.

In FIG. 13 is shown a further embodiment in which strips 68 are embedded within sidewalls 24 to provide thermal values which may be required by certain types of trees, or other vegetation, particularly when the present system is used in colder climates. Therein, a dedicated heater 70 is associated with the respective heat strips 68.

In FIGS. 14 and 15 is shown use concept of the present invention in an aquatic or marine environment 71 in which a condensate line 160 is in fluid communication with an output from a factory 72. Therein, transported condensate may comprise any non-toxic liquid output of the factory having some nutritional value to marine plant life 74. Therein, planters 120 (see FIG. 14) may be either stacked in a vertical fashion or, as is shown in FIG. 15, arranged in circular arrangement, or a combination of both may be employed. In the concept of FIGS. 14 and 15, after the marine vegetation 74 has grown to a sufficient extent, the planters may be removed from ocean 71 and harvested.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A plant watering, conservation, and pollution control system, comprising:
(a) a planter having a base, sidewalls, at least one drain hole, and vegetation root anchors depending from interior surfaces of said planter;
(b) an upwardly directed funnel having side overflow means in fluid communication with one of said interior surfaces of said planter; and
(c) a float switch in electrical communication with a vegetation sprinkler system, said float switch disposed within said funnel at a horizontal level of said planter to which filling thereof is desired.

2. The system as recited in claim 1, further comprising:
a volume of earth disposed within said planter.

3. The system as recited in claim 1, further comprising:
(d) a condensate pump in fluid communication with a condensate output of an air conditioning unit;
(e) a condensate line having an input in fluid communication with said pump and an output thereof in fluid communication with an interior of said planter; and
(f) means for electrical communication between said condensate pump and said float switch, thereby actuating said pump when a level of water or moisture within said planter drops below said predetermined level thereof.

4. A plant watering, water conservation and pollution control system, comprising:
(a) a planter having a base, sidewalls, at least one drain hole, and vegetation root anchors depending from interior surfaces of said planter;
(b) a condensate pump in fluid communication with a condensate output of an air conditioning unit;
(c) a condensate line having an input in fluid communication with said pump and an output thereof in fluid communicating with an interior of said planter; and
(d) moisture sensing means in fluid communication with a desired, pre-determined water or moisture fill level of said planter, said sensor in electrical communication with said condensate pump,
whereby lack or sufficient water or moisture at the level of said sensor will actuate said condensate pump thereby providing said condensate output thereof to said planter.

5. The system as recited in claim 4, further comprising:
(e) a vegetation sprinkler system; and
(f) means for selectably actuating said sprinkler system relative to said planter when water or moisture is sensed by said moisture sensing means, falls below a predetermined level.

6. The system as recited in Claim, further comprising:
a volume of earth disposed within said planter.

7. The system as recited in claim 5, further comprising:
(g) an upwardly directed funnel having a side overflow hole in fluid communication with an interior of said planter; and
(h) a float switch in electrical communication with a vegetation sprinkler system, disposed within said funnel, said float switch disposed at a level of said planter to which filling or moisturizing is desired.
